(19) United States
(12) Patent Application Publication
(10) Pub. No.: US 2026/0249491 A1
(43) Pub. Date: Aug. 27, 2026

(54) FOLDING KNIFE

(71) Applicant: Heinr. Böker Baumwerk GmbH Solingen, Solingen (DE)

(72) Inventor: Thomas WARD, JR., Mead, CO (US)

(73) Assignee: Heinr. Böker Baumwerk GmbH Solingen, Solingen (DE)

(21) Appl. No.: 19/059,726

(22) Filed: Feb. 21, 2025

(51) Int. Cl. B26B 1/04; B26B 1/10

(52) U.S. Cl. CPC B26B 1/044; B26B 1/10

(57) ABSTRACT

A folding knife includes a handle defined by a first handle half and a second handle half held at least partially in a spaced apart relationship to form an accommodation space. An insert is defined by a first insert shell and a second insert shell, the first insert shell being attached to the first handle half and the second insert shell being attached to the second handle half. A blade is pivotally connected between the insert shells with a pivot shaft extending through a bore in a tang of the blade, the blade being rotationally movable between a closed position in the accommodation space and an open position.

### FIELD

The present disclosure relates to folding knives, and more particularly to spring assisted opening knives.

### BACKGROUND

The statements in this section merely provide background information related to the present disclosure and may not constitute prior art.

Folding knives can comprise a handle having a pair of spaced apart handle halves defining an accommodation space therebetween and a blade pivotally movable relative to the handle between a closed position in the accommodation space and an open position. A locking mechanism can generally be included with these folding knives to retain the blade in at its open or closed position.

### SUMMARY

This section provides a general summary of the disclosure and is not a comprehensive disclosure of its full scope or all of its features.

According to an aspect, a folding knife comprises a handle defined by a first handle half and a second handle half held at least partially in a spaced apart relationship to form an accommodation space. An insert is defined by a first insert shell and a second insert shell, the first insert shell being attached to the first handle half and the second insert shell being attached to the second handle half. A blade is pivotally connected between the insert shells with a pivot shaft extending through a bore in a tang of the blade, the blade being rotationally movable between a closed position in the accommodation space and an open position.

The insert advantageously allows to interact with the tang of the blade in terms of force transmission. Forces not being directly transmitted from the blade to the handle allow a wider variability regarding the design of the handle, for example in terms of its form, material thickness and material properties. The insert shells can be form-fittingly connected to the respective handle halves with regards to a rotational movement. The material of the insert can for example have a higher hardness than the material of the handle. The hardness of the material may be understood as the hardness determined in a hardness test, like the Vickers hardness test. The harder insert is better suited for the transfer of forces from the blade, which forces usually act onto a small area. The insert transfers the forces further to the handle via a greater area, which means that for the handle far lower hardness demands apply. For example, the forces exerted by a spring for moving the blade can be received by the insert. However, the material of the insert may as well have a lower hardness than the material of the handle, for example, if the handle is made of a Titanium alloy. Still advantageously, the insert made of less hard material can be less expensive and/or less elaborate in processing

At least one torsion spring can be arranged around the pivot shaft, which torsion spring can have a first end fixed to the first insert shell and a second end fixed to the tang. According to an embodiment, at least one of the first insert shell and the second insert shell can have a circular groove formed concentrically around a central hub for receiving the at least one torsion spring. The central hub can receive the pivot shaft. At least one of the first insert shell and the second insert shell has a radial groove extending radially away from the circular groove for receiving the first end of the at least one torsion spring. The second end of the torsion spring can be arranged in an opening on the tang, which opening can move along the circular groove when the blade is moved.

According to a further embodiment, the insert can have a locking mechanism for reversibly locking the blade in at least one of the open position and the closed position. The locking mechanism may have a bolt movable transversely to a plane defined by rotation of the blade, the bolt having a first end mounted in a first mount on the first insert shell, with a compression spring between the first mount and the first end biasing the bolt towards the second insert shell. A second end of the bolt can be mounted in a second mount on the second insert shell, an operating button extending from the second end through an opening of the first handle half. The bolt may alternatively be mounted in the second mount on the second insert shell and be biased towards the first insert shell, with the operating button extending through an opening of the second handle half.

The insert can have a generally circular form, with at least one of the first mount, the second mount, a first stud mount and a second stud mount for receiving a stop stud extending radially beyond the generally circular form, thus providing a form-fitting connection to respective corresponding forms on at least one of the first handle half and the second handle half.

According to a further aspect, the folding knife comprises a handle defined by a first handle half and a second handle half held in a spaced apart relationship, an insert defined by a first insert shell and a second insert shell, the first insert shell being attached to the first handle half and the second insert shell being attached to the second handle half. A material of the insert has a higher hardness than a material of the handle. A blade is pivotally connected between the insert shells with a pivot shaft extending through a bore in a tang of the blade, the blade being rotationally movable between an open position and a closed position. A spring biases the blade towards the open position, said spring having a first end fixed to the first insert shell and a second end fixed to the tang.

According to a further aspect, the folding knife comprises a handle defined by a first handle half and a second handle half held in a spaced apart relationship, an insert defined by a first insert shell and a second insert shell, the first insert shell being attached to the first handle half and the second insert shell being attached to the second handle half. A blade is pivotally connected between the insert shells with a pivot shaft extending through a bore in a tang of the blade, the blade being rotationally movable between an open position and a closed position. A spring biases the blade towards the open position and at least one of the first insert shell and the second insert shell is form-fittingly connected to the respective one of the first handle half and the second handle half with regard to a rotational movement.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective, exploded view of an exemplary embodiment of a folding knife;

FIG. 2 is an enlarged view of portion A of FIG. 1;

FIG. 3 is an enlarged view of portion B of FIG. 1;

FIG. 4 is a perspective, exploded view of an insert of the embodiment of FIG. 1; and

FIG. 5 a perspective, exploded view of a second insert shell of the insert according to the embodiment of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

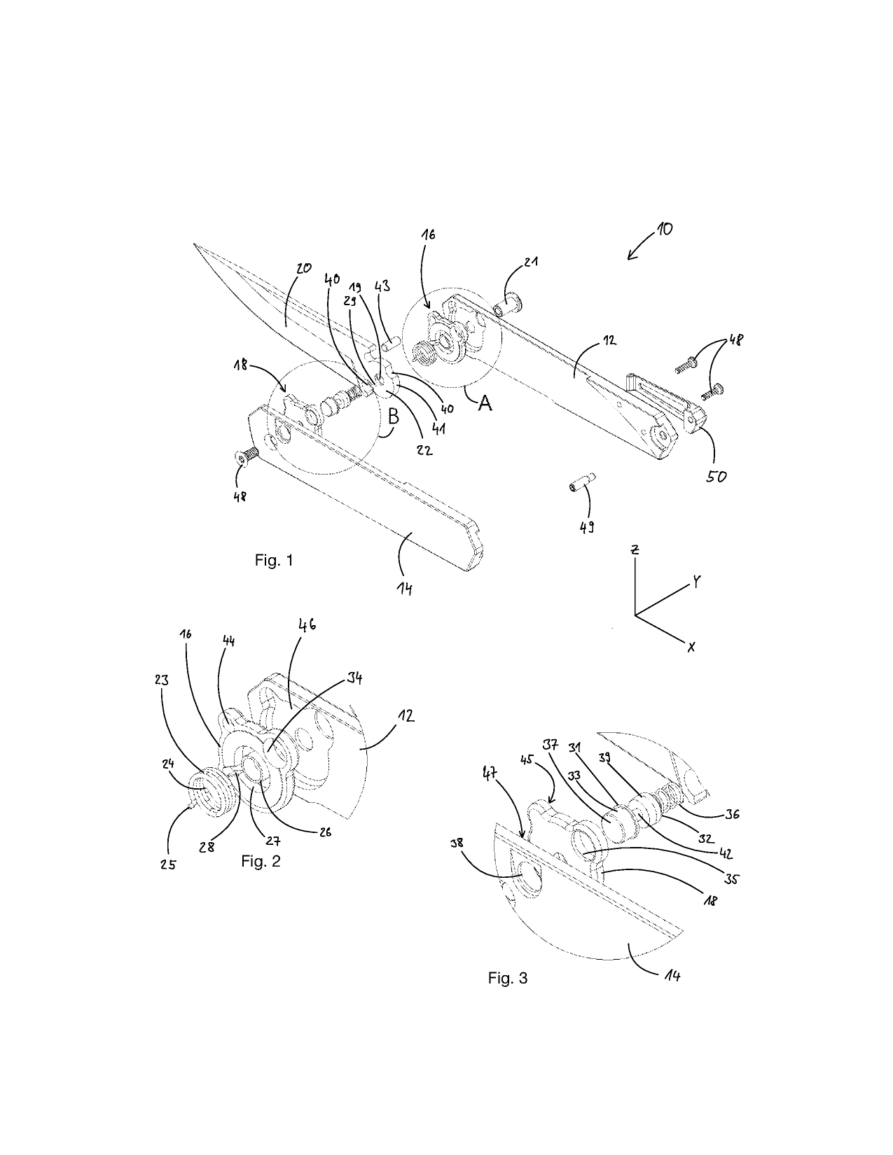

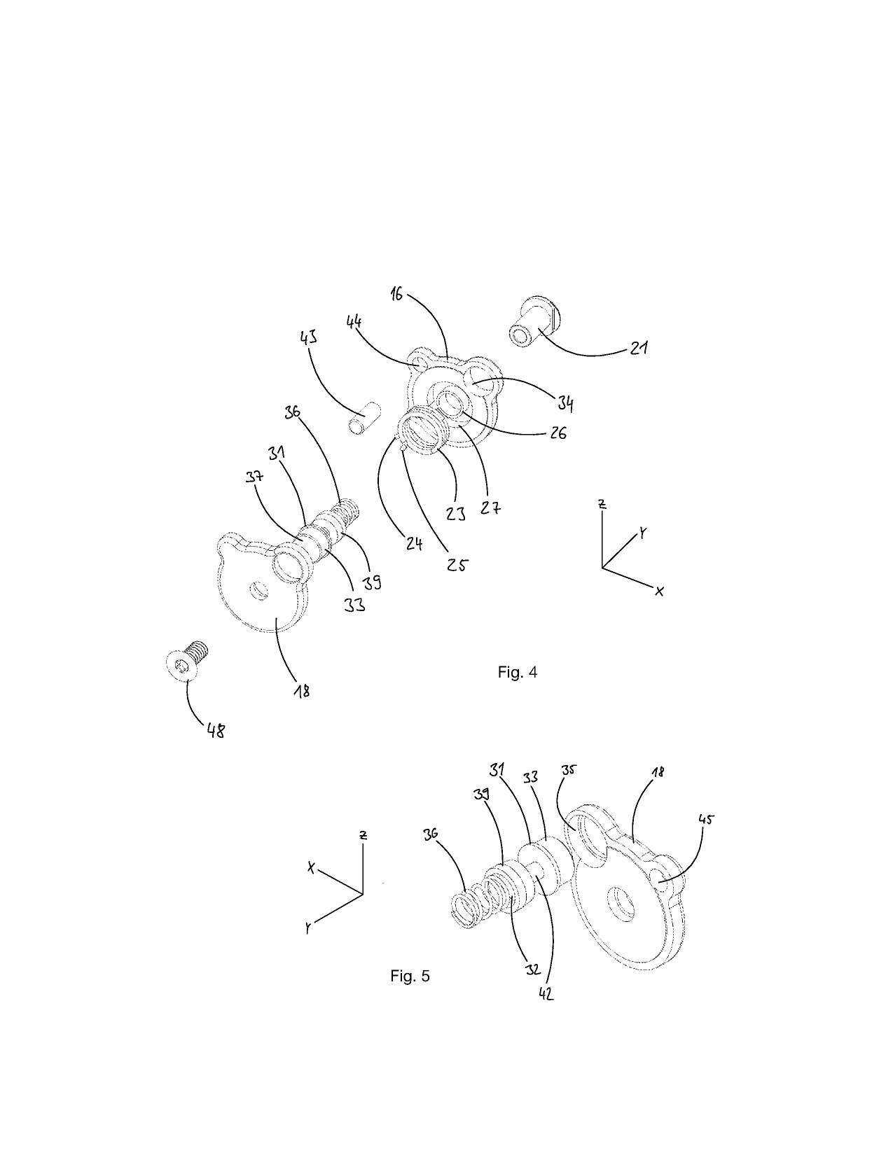

An exemplary embodiment of a folding knife is described with regard to the FIGS. 1 to 5, which are described together. In FIG. 1, the folding knife 10 is shown in a perspective exploded view. In FIG. 2, an enlarged detail of portion A of FIG. 1 is shown. In FIG. 3, a further enlarged detail of portion B of FIG. 1 is depicted. In FIG. 4, an insert of the embodiment of FIG. 1 is depicted in a perspective exploded view with a diverted perspective. In FIG. 5, a second insert shell 18 of the insert according to FIG. 1 is depicted in a perspective exploded view with a 180° rotated perspective. Spatial directions X, Y and Z are defined by cartesian coordinate systems depicted in FIG. 1 for FIGS. 1, 2 and 3, FIG. 4 and FIG. 5 to illustrate the respective perspective views.

The folding knife 10 comprises a handle defined by a first handle half 12 and a second handle half 14 held at least partially in a spaced apart relationship to form an accommodation space therebetween for a blade 20. An insert is defined by a first insert shell 16 and a second insert shell 18, the first insert shell 16 being attached to the first handle half 12 and the second insert shell 18 being attached to the second handle half 14. The blade 20 is pivotally connected between the first and second insert shells 16, 18 with a pivot shaft 21 extending through a bore 19 in a tang 22 of the blade 20, the blade 20 being rotationally movable between a closed position in the accommodation space and an open position, which is depicted in FIG. 1. The folding knife 10 can comprise a clip 50. One or more bolts 49 and/or fastening means 48 are provided for fastening the first handle half 12 to second handle half 14 to each other or the clip 50 to the one of the first handle half 12 or second handle half 14.

The first insert shell 16 and the second insert shell 18 are form-fittingly connected to the respective one of the first handle half 12 and the second handle half 14 with regard to a rotational movement. The first insert shell 16 is depicted in detail in a perspective view in FIG. 2, together with a torsion spring 23. The second insert shell 18 is depicted in detail in a perspective view in FIG. 3. A material of the insert shells 16, 18 has a higher hardness than a material of the handle halves 12, 14, which hardness can be determined by a hardness test, like the Vickers hardness test. The harder insert shells 16, 18 are better suited for the transfer of forces from the blade 20. For example, the forces exerted by the spring 23 for moving the blade 20 can be received by the insert shells 16, 18. The insert shells 16, 18 both have a generally circular form. The first insert shell 16 (FIG. 2) has a first mount 34 and first stud mount 44, extending radially beyond the generally circular form, thus providing the form-fitting connection to a corresponding form 46 on the first handle half 12. The second insert shell 18 (FIG. 3) has a second mount 35 and a second stud mount 45 extending radially beyond the generally circular form, thus providing the form-fitting connection to a form 47 on the second handle half 14, the respective corresponding forms 46, 47 being designed as depressions, for example, in the first handle half 12 and the second handle half 14.

The torsion spring 23 is arranged around the pivot shaft 21, the torsion spring 23 having a first end 24 fixed to the first insert shell 16 and a second end 25 fixed to the tang 22. The first and second insert shells 16, 18 each have a central hub 26 for receiving the pivot shaft 21. At least one of the first insert shell 16 and the second insert shell 18 has a circular groove 27 formed concentrically around the central hub 26 for receiving the at least one torsion spring 23. In the depicted embodiment, both insert shells 16, 18 have the circular groove 27, although only one torsion spring 23 is provided in the circular groove 27 of the first insert shell 16. The first insert shell 16 has a radial groove 28 extending radially away from the circular groove 27 for receiving the first end 24 of the torsion spring 23. For accommodating two torsion springs 23, the second insert shell 18 can have a corresponding radial groove as an alternative embodiment, which is not depicted. The tang 22 has an opening 29 for receiving the second end 25 of the torsion spring 23, the opening 29 moving along the circular groove 27 when the blade 20 is moved. Further, a stop stud 43 extends transversely to the plane defined by the rotation of the blade 20, the stop stud 43 being mounted in the first stud mount 44 on the first insert shell 16 and in the second stud mount 45 on the second insert shell 18. A stop on the tang 22 engages the stop stud 43 in the open position.

A locking mechanism 30 is provided for reversibly locking the blade 20 in at least one of the open position and the closed position. The locking mechanism 30 has a bolt 31 movable transversely to a plane defined by a rotation of the blade 20, the bolt 31 having a first end 32 mounted in the first mount 34 on the first insert shell 16. A compression spring 36 seated between the first mount 34 and a cup-formed accommodation at the first end 32 biases the bolt 31 towards the second insert shell 18. The bolt 31 has a second end 33 mounted in the second mount 35 on the second insert shell 18, an operating button 37 extending from the second end 33 through an opening 38 of the first handle half 12. The bolt 31 has a locking portion 39 for engaging one of two locking openings 40 arranged on a circumferential edge 41 of the tang 22 defining the open position and the closed position, wherein the bolt 31 has a releasing portion 42 adjacent to the locking portion 39, the releasing portion 42 having a smaller diameter than the locking portion 39, thus allowing the rotation of the blade 20 out of the open position and the closed position.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A folding knife, comprising:
a handle defined by a first handle half and a second handle half held at least partially in a spaced apart relationship to form an accommodation space;
an insert defined by a first insert shell and a second insert shell, the first insert shell being attached to the first handle half and the second insert shell being attached to the second handle half; and
a blade pivotally connected between the first and second insert shells with a pivot shaft extending through a bore in a tang of the blade, the blade being rotationally movable between a closed position in the accommodation space and an open position.

2. The folding knife according to claim 1, wherein at least one of the first insert shell and the second insert shell is form-fittingly connected to a respective one of the first handle half and the second handle half with regard to a rotational movement.

3. The folding knife according to claim 1, wherein a material of the insert has different material properties than a material of the handle.

4. The folding knife according to claim 1, further comprising at least one torsion spring arranged around the pivot shaft, the at least one torsion spring having a first end fixed to the first insert shell and a second end fixed to the tang.

5. The folding knife according to claim 1, wherein the first and second insert shells each have a central hub for receiving the pivot shaft.

6. The folding knife according to claim 5, wherein at least one of the first insert shell and the second insert shell has a circular groove formed concentrically around the central hub for receiving at least one torsion spring.

7. The folding knife according to claim 6, wherein at least one of the first insert shell and the second insert shell has a radial groove extending radially away from the circular groove for receiving a first end of the at least one torsion spring.

8. The folding knife according to claim 6, wherein the tang has an opening for receiving a second end of the at least one torsion spring, the opening moving along the circular groove when the blade is moved.

9. The folding knife according to claim 1, wherein the insert has a locking mechanism for reversibly locking the blade in at least one of the open position and the closed position.

10. The folding knife according to claim 9, wherein the locking mechanism has a bolt movable transversely to a plane defined by a rotation of the blade, the bolt having a first end mounted in a first mount on the first insert shell, a compression spring between the first mount and the first end biasing the bolt towards the second insert shell.

11. The folding knife according to claim 10, wherein the bolt has a second end mounted in a second mount on the second insert shell, an operating button extending from the second end through an opening of the first handle half.

12. The folding knife according to claim 1, wherein the insert has a stop stud extending transversely to a plane defined by a rotation of the blade, the stop stud being mounted in a first stud mount on the first insert shell and in a second stud mount on the second insert shell, a stop on the tang engaging the stop stud in the open position.

13. The folding knife according to claim 12, wherein the insert has a generally circular form, with at least one of the first mount, the second mount, the first stud mount and the second stud mount extending radially beyond the generally circular form, thus providing a form-fitting connection to respective forms on at least one of the first handle half and the second handle half.

14. A folding knife, comprising:
a handle defined by a first handle half and a second handle half held in a spaced apart relationship;
an insert defined by a first insert shell and a second insert shell, the first insert shell being attached to the first handle half and the second insert shell being attached to the second handle half;
a blade pivotally connected between the first and second insert shells with a pivot shaft extending through a bore in a tang of the blade, the blade being rotationally movable between an open position and a closed position; and
at least one spring biasing the blade towards the open position, the at least one spring having a first end fixed to the first insert shell and a second end fixed to the tang;
wherein a material of the insert has different material properties than a material of the handle.

15. The folding knife according to claim 13, wherein the insert has a locking mechanism for reversibly locking the blade in at least one of the open position and the closed position, the locking mechanism having a bolt movable transversely to a plane defined by a rotation of the blade, the bolt having a first end mounted in a first mount on the first insert shell, a compression spring between the first mount and the first end biasing the bolt towards the second insert shell.

16. The folding knife according to claim 15, wherein the bolt has a second end mounted in a second mount on the second insert shell, an operating button extending from the second end through an opening of the first handle half.

17. The folding knife according to claim 15, wherein the bolt has a locking portion for engaging at least one locking opening arranged on a circumferential edge of the tang defining at least one of the open position and the closed position, wherein the bolt has a releasing portion adjacent to the locking portion, the releasing portion having a smaller diameter than the locking portion, allowing the rotation of the blade.

18. A folding knife, comprising:
a handle defined by a first handle half and a second handle half held in a spaced apart relationship;
an insert defined by a first insert shell and a second insert shell, the first insert shell being attached to the first handle half and the second insert shell being attached to the second handle half;
a blade pivotally connected between the first and second insert shells with a pivot shaft extending through a bore in a tang of the blade, the blade being rotationally movable between an open position and a closed position; and
a spring biasing the blade towards the open position;
wherein at least one of the first insert shell and the second insert shell is form-fittingly connected to a respective one of the first handle half and the second handle half with regard to a rotational movement.

19. The folding knife according to claim 18, wherein the insert has a locking mechanism for reversibly locking the blade in at least one of the open position and the closed position, the locking mechanism having a bolt with a first end mounted in a first mount on the first insert shell and a second end mounted in a second mount on the second insert shell, wherein the insert has a generally circular form, with at least one of the first mount and the second mount extending radially beyond the generally circular form, thus providing a form-fittingly connection to respective forms on the first handle half and the second handle half.

20. The folding knife according to claim 18, wherein the insert has a stop stud extending transversely to a plane defined by a rotation of the blade, the stop stud being mounted in a first stud mount on the first insert shell and in a second stud mount on the second insert shell, a stop on the tang engaging the stop stud in the open position, and wherein the insert has a generally circular form, with at least one of the first stud mount and the second stud mount extending radially beyond the generally circular form, thus providing a form-fittingly connection to respective forms on the first handle half and the second handle half.
